(19) United States
(12) Patent Application Publication
(10) Pub. No.: US 2012/0150553 A1
(43) Pub. Date: Jun. 14, 2012

(54) SYSTEMS FOR FACILITATING CREATION AND MANAGEMENT OF ITEM LISTS WITH UNIQUE IDENTIFICATION CODES FOR ITEMS AND ASSOCIATING THE LISTS TO SPONSOR'S PAYMENT FINANCIAL TRANSACTION CARD PROGRAMS

(76) Inventor: Devin Wade, Redwood City, CA (US)

(21) Appl. No.: 13/118,147

(22) Filed: May 27, 2011

Related U.S. Application Data
(60) Provisional application No. 61/422,471, filed on Dec. 13, 2010.

(51) Int. Cl. G06Q 50/00; G06Q 30/00

(52) U.S. Cl. 705/2; 705/27.2

(57) ABSTRACT

A system is provided for multiple retailers to participate in restricted spend card programs. A retailer infrastructure includes a point of sale server coupled to a store concentrator and to a product tables/price book(s). An adjudication processor is coupled to the retailer. A catalog management processor includes a server coupled to the adjudication processor. The catalog management processor creates a catalog of UPC's for each of a participating retailer. Each catalog includes first and second sets of UPC data. The first set is for national brand products and the second set is for retailer private label products.

### RELATED APPLICATIONS

This application claims the benefit of U.S. Ser. No. 61/422,471, filed Dec. 13, 2010, U.S. Ser. No. 13/117,003, filed May 26, 2011, and U.S. Ser. No. 13/117,010, filed May 26, 2011, all of which are incorporated by reference.

### BACKGROUND

1. Field of the Invention

The present invention relates generally to systems for facilitating the creation and management of item lists, and more particularly those with unique identification codes for each item that includes the associating of the lists to a sponsor's payment financial transaction card program to determine if a payment financial transaction card associated with a specified financial transaction card program can be used to pay for items presented for purchase.

2. Description of the Related Art

Many managed healthcare providers offer their members discounts on prescription drugs. However, only a few managed healthcare providers also offer their members discounts for Over The Counter (OTC) drugs. Therefore, it is common for members to go to the emergency room for ailments such as runny noses and coughs. These visits and often the pharmaceuticals prescribed in those visits are typically very expensive and are often covered by the managed health card providers.

Many of these visits and their associated costs could be eliminated if the members were given a fixed monthly dollar amount to spend on OTC products, such as OTC cough syrups, antihistamines, aspirins, etc. The few managed healthcare providers that offer OTC benefits to their members have traditionally attempted to accomplish this using paper vouchers or forms that were given to the members and redeemed at the retail stores. These traditional methods were often fraught with mistakes and did not provide the ability to offer any reporting capabilities associated with the methods.

In one system and method for facilitating redemption of benefits for a customer, a benefit financial transaction card is provided that includes associating an identification code with the customer. The identification code is stored on the benefit financial transaction card. An account record associated with the identification code is accessed and a determination is then made to ascertain if an item presented for purchase by the customer is eligible for a benefit discount. An appropriate discount for the item is calculated if it is determined that the item is eligible for a benefit discount.

Current methods address multiple entities relative to managed care providers and a plurality of entities in terms of retailers, but fail to provide for the complexities inherent in a many-to-many scenario of creating, associating and managing eligible item list(s). A single managed care organization and one item list plus a single retailer brand is fairly straightforward. However, multiple organizations with more than one item list accepted at multiple retailers is a more complex scenario. With current methods, the list itself is identified. However, current methods fail to create, associate and manage the list even though the resulting output of the list is a necessary in order to perform the item match at point of purchase based on the presenting payment or ID mechanism.

Most U.S. health plans provide benefit coverage for healthcare related items at retail stores. Examples include but are not limited to, allergy medications, cough and cold remedies, pain relievers, vitamins, and the like.

The Federal government, through the Department of Health and Human Services, and more specifically Centers for Medicare and Medicaid restrict the use of benefit funds being directed to one retailer brand. At the same time, they do not require health plans to offer the same list of eligible items, so long as the items are a subset of the overall approved list and that they are offered to all members.

Current methods do not address how eligible item list(s) are created, associated with a financial transaction card program and managed on an ongoing basis. Current methods only address that the item presented for purchase by the customer is determined to be eligible or non-eligible based on a list. A list provided by a managed card provider or employer in the example of a flex benefit financial transaction card.

Medicare and Medicaid benefits represent billions in annual spend opportunity. In many cases, participating buyers do not access these funds due to the complexity and inconvenience associated with the current process. The convenience of an electronic process at the front of the store bring more participating buyers to participating retailers and increases retailer revenues from eligible product sales. Financial transaction card holders pay full retail price with the financial transaction card at any POS in the store, including but not limited to a pharmacy counter.

There is a need for systems and methods for several retailers to publish which items they sell and add their own private label items to lists of eligible items. There is a further need for several health plans (or sponsors) to have (i) a starting point in the form of an approved master list; (ii) the ability to view item matches from multiple participating retailers; (iii) the ability to create a subset from that list; (iii) an ability to create a custom list; and (iv) associate that list with a specific payment mechanism funded by the sponsor.

### SUMMARY

Accordingly, an object of the present invention is to provide systems to automate the creation and association of item lists invoked at the time of purchase from a point-of-sale device in determining if the item presented is eligible to be purchased by the payment mechanism presented (e.g., magnetic financial transaction card swipe).

Another object of the present invention is to provide that allow retailers the ability to make it known which items they sell within a specific list of items and the ability to add their own private label products to those lists.

A further object of the present invention is to provide systems that allow sponsors the ability to create item lists and to associate those lists with payment programs for purposes of settlement with the retailers selling the eligible items to the members of the sponsor.

Yet another object of the present invention is to provide systems that allow sponsors of each list to determine publishing settings.

These and other objects of the present invention are achieved in a system for multiple retailers to participate in restricted spend card programs. A retailer infrastructure includes a point of sale server coupled to a store concentrator and to a product tables/price book(s). An adjudication processor is coupled to the retailer. A catalog management processor includes a server coupled to the adjudication processor. The catalog management processor creates a catalog of UPC's for each of a participating retailer. Each catalog includes first and second sets of UPC data. The first set is for national brand products and the second set is for retailer private label products.

### BRIEF DESCRIPTION OF THE DRAWINGS

FIG. 1 is an overall system architecture of one embodiment of the present invention outside of a retailer network infrastructure.

FIG. 2 is an overall system architecture of one embodiment of the present invention inside a retailer network infrastructure.

FIG. 3 is a flow chart illustrating operation of a market basket analysis server used in one embodiment of the present invention.

FIG. 4 is a flow chart illustrating market basket adjudication in one embodiment of the present invention.

FIG. 5 is a flow chart illustrating the operation of a switch of an adjudication processor in one embodiment of the present invention.

FIG. 6 illustrates an embodiment of a process flow for publishing catalogs.

### DETAILED DESCRIPTION

Systems and methods are provided for facilitating multiple retailers to automate the process of matching items presented at point of purchase with the buyer selected financial transaction financial transaction card to determine if the items presented are permitted to be purchased by the presented financial transaction financial transaction card. More particularly, the present invention provides for the matching of items to multiple item lists for sponsor associated payment/settlement programs.

With the present invention, systems and methods are provided for implementing a financial transaction card program having buyers. The buyers are restricted to purchase select items from select retailers and the retailers are part of a private host-to-host network having the ability to communicate messages to and from a network computer. Each buyer has a unique identification code that corresponds with a list of selected items and a list of selected retailers.

With the present invention, systems and methods are provided to implement an adjudication process which allows a market basket utilized with product catalogs. Each catalog contains a list of Universal Product Codes (“UPC”), each identifying an item that can be purchased by a financial transaction card. A purse is an identifier for a financial account associated with a financial transaction card. As non-limiting examples, the financial account can be a bank account, credit financial transaction card, debit financial transaction card, pre-paid financial transaction card, a third party funding source and the like. As non-limiting examples, a financial transaction card can be, the financial transaction card is selected from at least one of, credit financial transaction card, debit financial transaction card, gift financial transaction card, fund transfer financial transaction card, other types of payment authenticating piece capable of carrying out a transfer of funds and the like In one embodiment, a financial transaction card, including but not limited to a debit or credit financial transaction card, has multiple financial transaction institutions or purses. The financial transaction card can also have only one spending purse. Items in the market basket are adjudicated against the one or more associated catalogs.

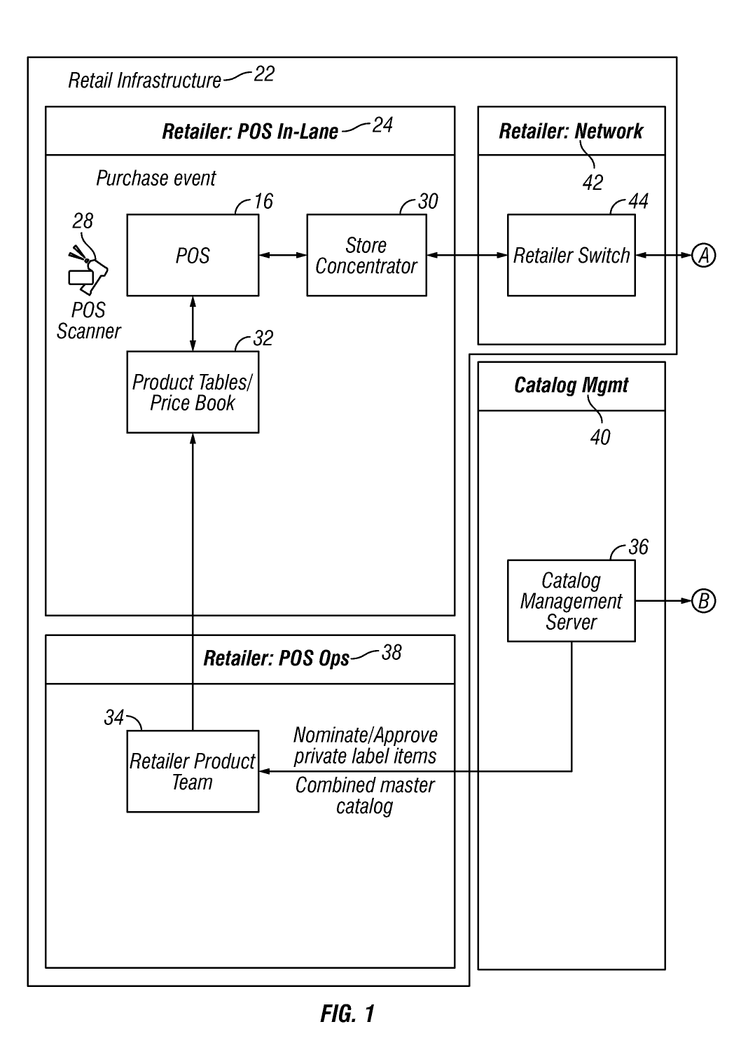

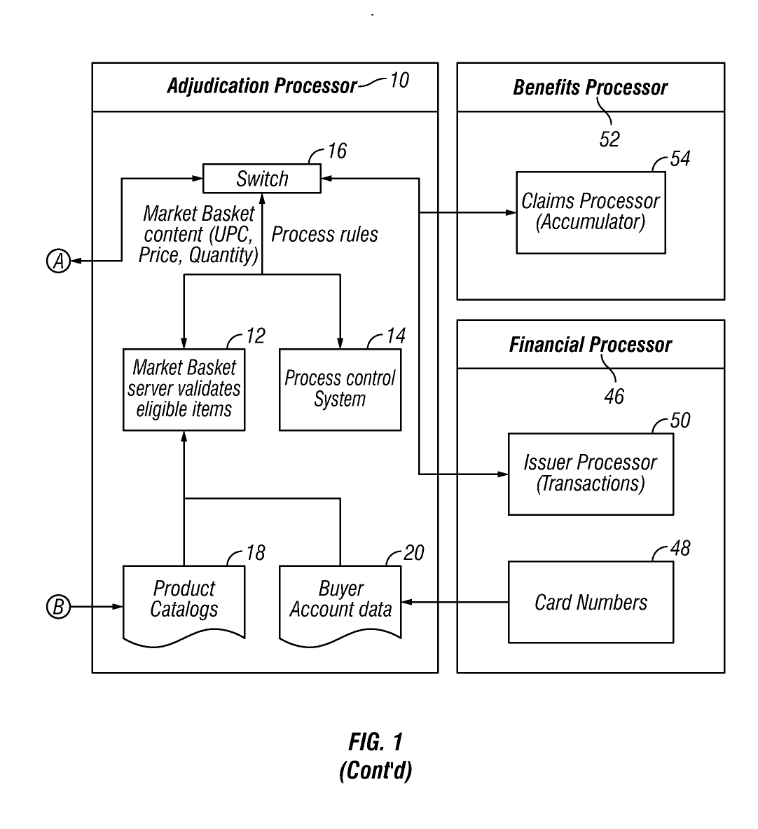

As illustrated in FIG. 1, an adjudication processor 10 includes a market basket analysis server 12, a process control server 14, a switch 16, product catalogs 18 and buyer account data 20.

More generally, in FIG. 1, a retailer infrastructure, denoted as 22, includes a retailer: POS In-Lane 24, hereafter (retailer 24). The retailer 24 includes a point of sale server (POS) 26, with a bar code scanner 28, that is coupled to a store concentrator 30 and to a product tables/price book(s) 32. A retailer product team 34 is in communication with the product tables/price book(s) 32 and to a catalog management server 36. The retailer product team 34 is part of a retailer: POS Ops 38.

The catalog management server 36 is included in a catalog management processor 40. The retailer infrastructure 22 also includes a retailer network 42 with a retailer switch 44.

The retailer switch 44 is coupled to the adjudication processor 10. The market basket analysis server 12 is coupled to the product catalogs 18 and validates eligible items in the market basket, as more fully discussed hereafter. The contents of the market basket, including but not limited to, UPC, price, quantity and the like, are communicated between the market basket analysis server 12 and the switch 16, from the retailer switch 44. The catalog management server 36 communicates with the market basket analysis server 12 in the form of the product catalogs 18.

A financial transaction financial transaction card issuer, hereafter (financial processor 46) is coupled to the adjudication processor 10 and includes financial transaction card numbers 48 and an issuer processor (transactions) 50.

A benefits processor 52 includes a claims processor (accumulator) 54 coupled to switch 16. The benefits processor 52 is in communication with the switch 16. The market basket analysis server 12 can contact the benefit processor 52 via the switch 16 in real time and receive a claim authorization. The benefits processor 52 can communicate via standard prescription languages, NCPDP5.1 and NCPDP d.0.

Account information 56 includes buyer account data 20 that is provided to the market basket analysis server 12 and relates to financial transaction financial transaction card numbers 48, originating with the financial processor 46 that includes an issuer processor 50 (transactions). The issuer processor 50 communicates with a switch 58 and to switch 16 where financial approval transactions are required.

As previously recited, the present invention facilitates multiple retailers to automate the process of matching items presented at POS 26 purchase with the buyer selected payment mechanism to determine if the items presented are permitted to be purchased by the presented payment mechanism. More particularly, the present invention provides for the matching of items to multiple item lists for sponsor associated payment/settlement programs.

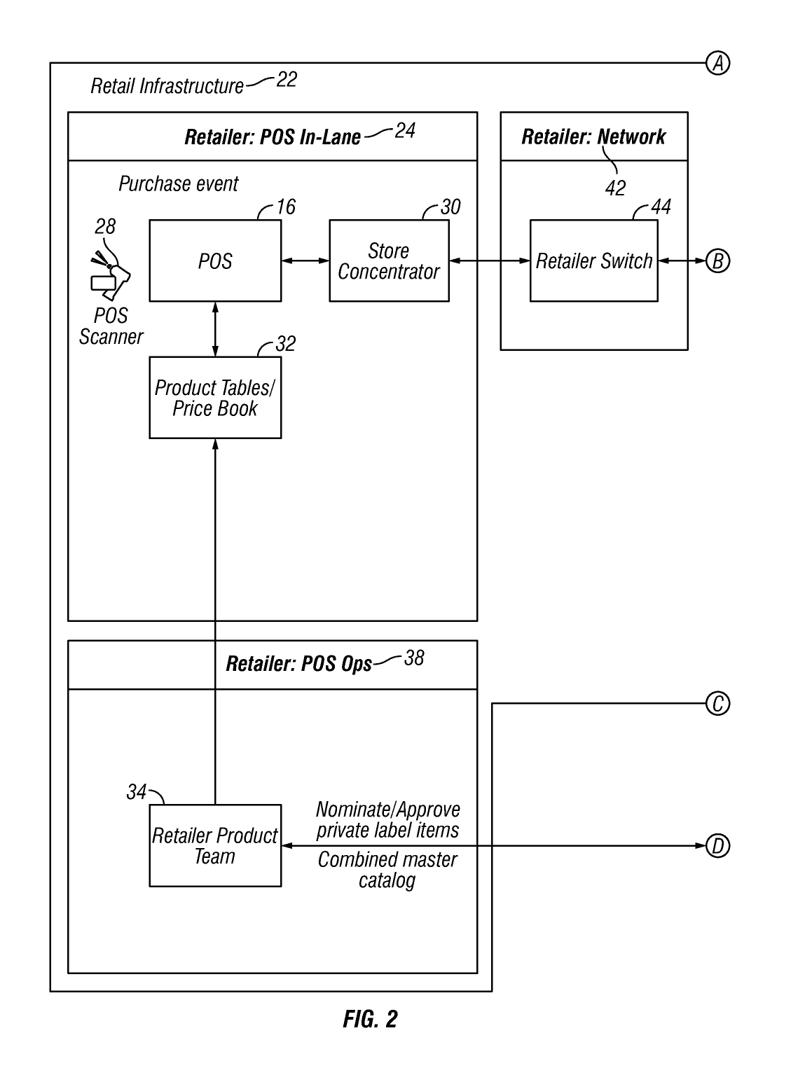

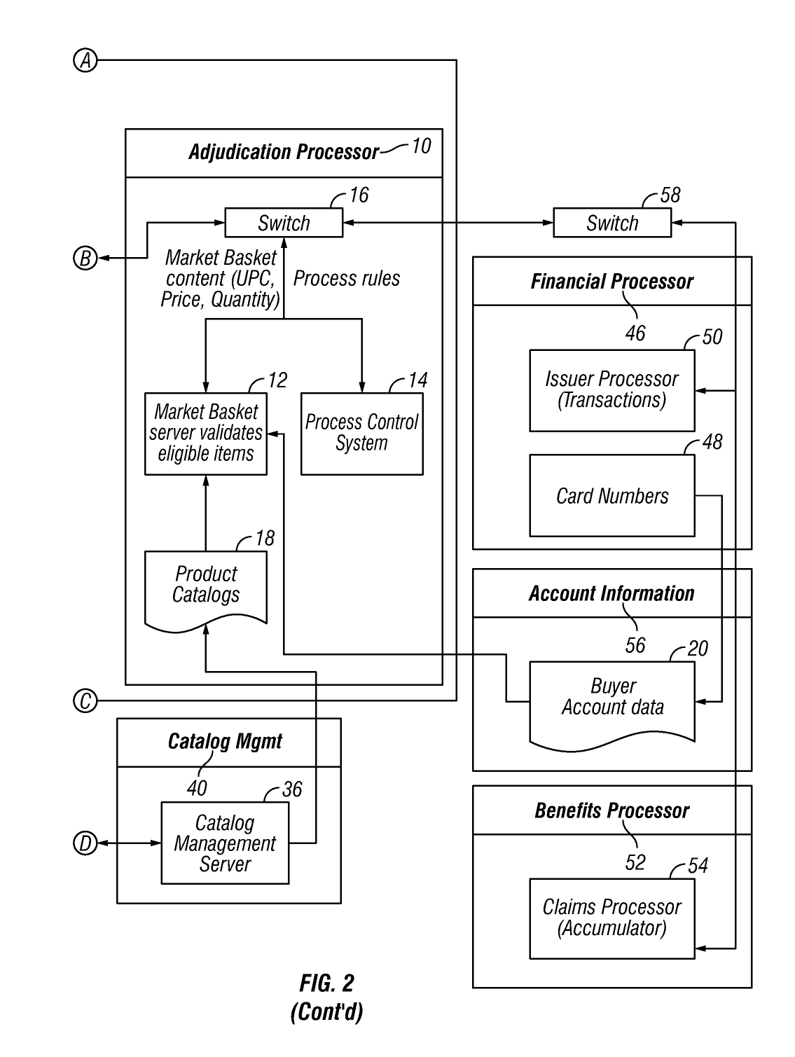

In the FIG. 2 embodiment, the adjudication processor 10 is included in the retail infrastructure 22. The overall system architecture in the FIG. 2 embodiment includes switch 58 to communicate with retailer processes that are behind the retailer firewall.

The adjudication process utilizes components in the adjudication processor 10. In combination, the switch 16, market basket analysis server 12, catalog management server 36, and the process control server 14 provide adjudication. In one embodiment, the adjudication process also can authorize the financial transaction.

Financial transactions that are triggered by a retailer in-lane purchase activity are typically communicated in the form of ISO 8583 from the retailer switch 44 to the switch 16. The switch 16 decomposes the ISO 8583 message into messages suitable for processing by subsequent processing components, such as the market basket analysis server 12.

In one embodiment, the switch 16 communicates the market basket content data and transaction identification information to the market basket analysis server 12, in the data form that has been parsed and formatted by the switch 16.

The market basket analysis server 12 compares the market basket contents to the product catalog(s) 18. Product catalog(s) 18 have been previously loaded to market basket analysis server 12 from catalog management server 36. Product catalogs 18 contain an items list of approved products, identified by UPC and short description. Market basket line item content data is processed iteratively by the market basket server 12.

With the present invention, adjudication to a plurality of catalogs 18 can be processed. With the present invention, a catalog 18 is directly related to an account purse. This purse can be associated to a restricted spend based upon the catalog 18 that is used to adjudicate an item list. For example, a financial transaction financial transaction card may support spending against a food items catalog and also an over-the-counter drug item catalog. One or more spending purses, each with a specific spending balance from a specific Issuer may be identified to a single financial transaction financial transaction card.

With the present invention, the retailer 24 collects the market basket and upon a swipe or scan of a buyer's financial transaction financial transaction card, packages up the market basket sends it to the adjudication processor 10 with either, (i) the retailer processing the purchase request, or (ii) the adjudication processor processing the purchase request. Incoming and outgoing communications between the retailer 24 and the adjudication processor 10 can via an ISO 8583 message format, an XML web services format, and the like, all as real time interchanges. As a non-limiting example, entering can be done by at least one of, swiping the financial transaction financial transaction card through a slot of a financial transaction card reader coupled to the mobile device, through a slot of the mobile device, scanning, through wireless communication, touch of the financial transaction financial transaction card to the mobile device, by typing in information at the mobile device, photos, selecting a financial transaction financial transaction card from an application on a mobile device and from an on-line entity.

As illustrated in FIGS. 1 and 2, the retailer communicates with the retailer switch 44 which pushes transaction data to the adjudication processor 50. The switch 16 receives the transaction and processes it to conclusion. The switch 16 is the gateway for all types of transactions. A transaction may be one of many types. In one embodiment of the invention a transaction may be an adjudication request, an authorization request, or a POS result transaction. The switch 16 determines the nature of the transaction request 56 and formats data and routes the request through subsequent processes as determined by the type of request.

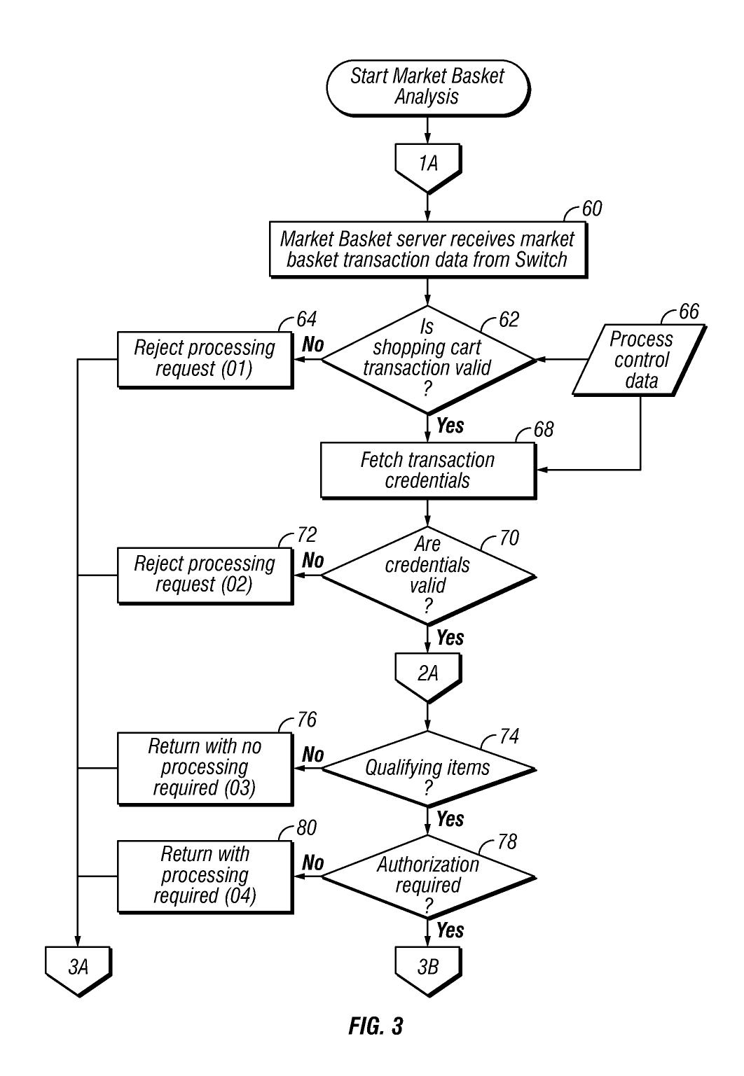

FIG. 3 is a flow chart illustrating operation of the market basket server 12 with steps 60-80. The market basket analysis server receives market basket transaction data from the switch 16 and determines if the market basket transaction is valid. If it isn't, then the processing request is rejected. If it is valid, then the market basket server 12 retrieves transaction credentials from process control data. If the credentials are not valid then the processing request is rejected. When the credentials are valid, a determination is made to see if there are qualifying items from the market basket. If not then the there is a return with no processing required. If yes, authorization is required and then returned with processing required.

The adjudication transaction contains transaction identification and market basket information as formatted and forwarded to the market basket server process. The authorization transaction contains transaction identification and requests for financial authorization against a specific financial payment account (purse). The result transaction contains transaction identification information, processed market basket adjudication transaction (market basket items flagged to a specific purse and catalog), and financial authorization information.

The market basket server 12 receives an adjudication transaction from the switch 16. The market basket server 12 processes the entire financial transaction financial transaction card to the extent possible and returns the transaction result to the switch for further processing as required. The switch 16 receives the adjudication transaction and determines if further processing is required. The adjudication transaction may require that the switch 16 obtain financial transaction authorization from one or more issuers. The switch 16 formats the transaction information 60 for routing and processing by the issuer.

The switch 16 waits to complete a transaction to the retailer 24 until authorization request(s) are processed and returned by the issuer(s). Authorization information is formatted and returned to the retailer 24 and the transaction is added to a permanent data log of all transactions passing through the switch 16. The switch 16 formats POS result transaction and returns to the retailer 24 and the transaction is added to a permanent data log of all transactions passing through the switch 16.

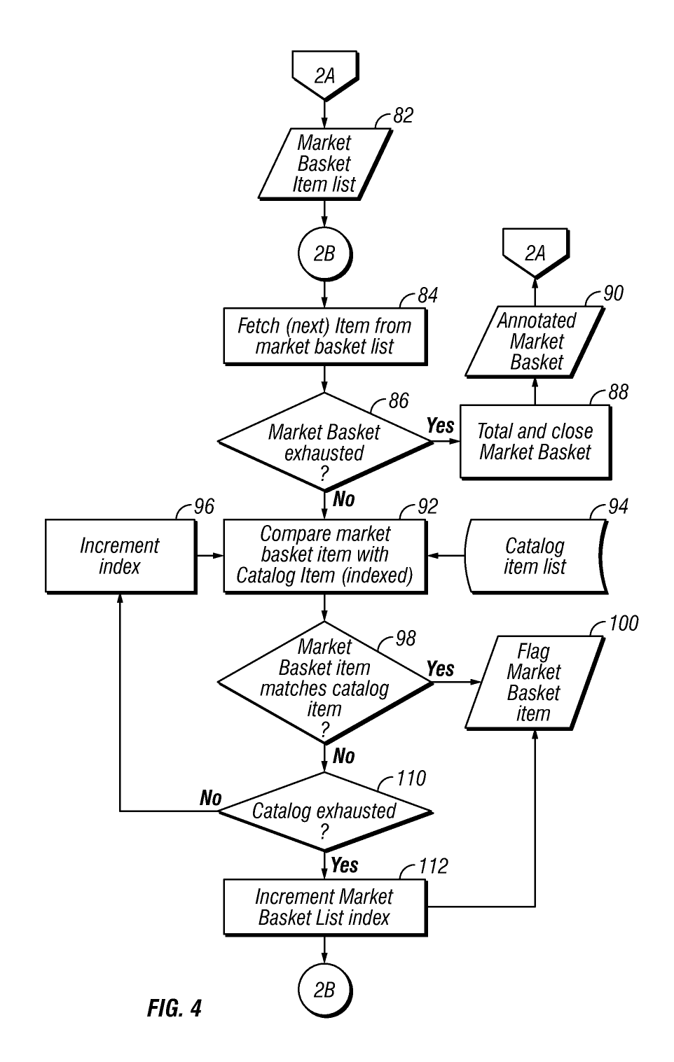

Referring to the market basket adjudication flow chart of FIG. 4 with steps 82 through 112, the market basket item list is received using the market basket analysis server 12 and the switch 16. When the market basket is exhausted a total is made of the items, the market basket is closed, and an annotated market basket created. If it is not exhausted then items from the market basket are compared with indexed catalog items. When there isn't a match with catalog items the catalog 18 is exhausted and an index incremented. Then the catalog 18 is not exhausted the market basket list index is incremented and the item is flagged.

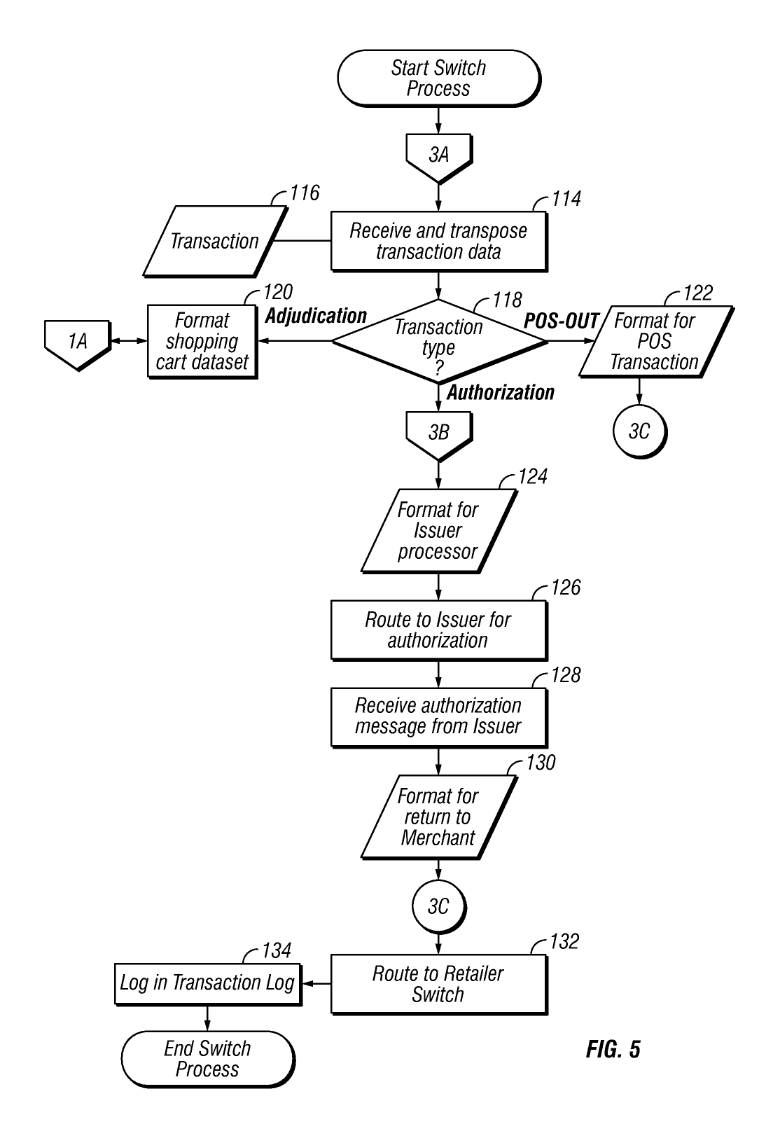

The operation of the switch 16 is illustrated in FIG. 5 in steps 114 through 134. The switch 16 receives and transposes transaction data received from a transaction. A determination is made by the switch 16 as to the type of transaction. When the transaction is adjudication, the market basket is formatted. For a POS-OUT transaction, it is formatted for POS. The switch 16 then performs authorization, formats the transaction for the financial processor 46 and then routes 508 to the issuer for authorization. An authorization message 509 is received from the financial processor 46. The switch 16 formats this and returns it to the retailer 24 via the retailer switch 44. The transaction is then logged in a transaction log.

There are multiple authorizations for multiple purses. The switch 16 is configured to couple to multiple financial processors 40 when there are multiple authorizations. The switch 16 can couple to multiple financial processing systems, to process restricted spending against multiple purses tied to multiple issuer processors. Based upon rules provided by the process control server 14, the switch bifurcates the financial transactions to multiple financial financial transaction card issuers and receives authorization from multiple financial processors.

With the present invention the market basket analysis server 12 isolates a buyer's financial account information from the reliance for regulatory compliance of HIPAA and PCI-DSS.

The retailer 24 is isolated from the details of multiple purses, multiple financial transaction financial transaction card issuers member demographics and the like. The PAN of a transaction ties to an account structure that defines the applicable process control rules. Process control rules are provided to the switch 16 from the process control server 14, to establish the path of the financial authorizations. A financial transaction financial transaction card number 48 and associated catalogs 18 with that financial transaction financial transaction card are provided in order for the market basket analysis server 12 to use the catalogs with a purse.

The adjudication processor 10 does not send the retailer member demographics. A financial transaction financial transaction card number 48 and associated catalogs 18 with that financial transaction financial transaction card are provided in order for the market basket analysis server 12 to use the catalogs related to the PAN, financial transaction financial transaction card issuers, and purses.

With the present invention the following steps are taken.

A collection of item data is received, e.g., the market basket. Each item in the market basket has a universal product code (“UPC”) to uniquely identify the item and has a quantity, net price and added tax as determined by the retailer price list.

Each item in a market basket is evaluated and compared by the UPC to items approved for the specific purse as related to the product/plan product catalog 18. Each item in the market basket is marked as eligible or ineligible to a specific product/plan. Eligible items are grouped according to a product/plan and a calculation is made of a total cost of all items, less appropriate discounts and allowances, for each group. Items, group totals, and market basket identification information is formatted into XML data structures, ISO8583, NCPDP 5.1 or NCPDP d.0, for further processing by the retailer 24, benefit processor 52 and the like.

Adjudication can be hosted at a retailer 24 and be internal to the retailer, or adjudication can be hosted external to the retailer and have several retailers connecting to it.

XML data structure is pushed to the switch 16. The switch 16 is utilized to translate data in the retailer specified format for systems hosted within the retailer network and into ISO8583, XML, NCPDP 5.1 or NCPDP d.0 formats for processing by issuer processor 50 or claims processor 54. An XML-based financial authorization request or ISO8583 based financial authorization request is initiated where the financial processor is not integral to the internal retailer network, and where the retailer requires that transactions be initiated by the present invention. In this instance, the system and method of the present invention process control server 14 determines the content of the authorization request against group totals and the switch 16 builds and transmits XML-based authorization requests to the financial processor 46. The switch 14 formats XML-based authorization requests in formats required by the corresponding issuer processor.

Items selected by the buyer and placed in the market basket are presented for purchase to the check out process of the participating retailer 24. This process may be a physical lane within a retail store, a collection of market basket items selected from a catalog and identified by the buyer at the time of check out, or the presentation of a script at a retail store, on-line or telephone based pharmacy counter, among other processes.

The process of using the retailer physical checkout lanes or the retailer physical pharmacy counter requires that market basket items be scanned or hand entered into the retailers store POS 26. The process of using catalog 18, on-line or telephone shopping requires that items be selected and identified by the shopping method and entered as items in the market basket.

Regardless of the method of shopping, all market basket item data, including price, quantity, taxes, point-of-purchase driven discounts are packaged into a single transaction and formatted according to the stores point-of-sale system message specifications. The single transaction must also include retailer identification information and buyer identification information, which at a minimum can include:

### 1. Retailer ID

### 2. Store ID

### 3. Terminal ID

### 4. PAN—Primary Account Number

### 5. Timestamp

### 6. STAN—System Trace Audit Number

7. Line item detail <per unique market basket item>
a. UPC
b. Net price
c. Tax
d. Quantity
e. Brief item description

This transaction comes from the POS 26 to the store concentrator 30 to retailer switch 44 and then to the switch 16. The transaction data can include item data and customer identifier (financial transaction financial transaction card number) data, and the like. Communication is via the retailers 24, store concentrator 30 and to the retailer switch 44. All of the retailers 24 are connected to the network, and data goes from the retailer switch 44 to the retainers 24, and then to another switch inside the retailer. The switch 16 utilizes the retailer switch 44 or to an internal retailer switch with communications to the retailer 24 being in a variety of methods, including but not limited to, ISO 8583 or XML data structures.

Transaction data is received from the originating retailer 24. The market basket transaction is directed from the market basket server 12 to the switch 16. The switch 16 formats the data into an XML data structure, from whatever retailer structure that was received, and transmits the translated XML structure to the market basket analysis server 12.

The market basket analysis server 12 utilizes the PAN to determine the catalogs 18 and purses for the buyer account. The buyer's personal information is not retrieved at any point in during adjudication or financial transaction processing. The buyer PAN relates one or more specific product catalogs to the market basket transaction.

If the buyer identifier, e.g., the account number of a financial transaction financial transaction card (PAN) is not recognized by the switch 16, an error occurs and there is a rejection. If the PAN there is an error, the switch 16 returns a message to the originating retailer 24 that the transaction is declined.

The switch 16 matches the item data received in the market basket transaction, one item at a time. The switch 16 appends two indicators to each line item of the market basket. A flag is produced that communicates if the item is eligible or not eligible, and an indicator of the group (catalog) 18 is also determined to which the item belongs.

Upon completion of processing, each item in the market basket and totals by each group are used to package the market basket transaction and returned to the retailer 24 for processing. In another embodiment, the processed market basket transaction is returned to the switch 16.

Upon receipt of the processed market basket transaction the market basket analysis server 12 matches the buyer identifier to the financial transaction financial transaction card issuer associated with the buyer identifier.

The switch 16 creates an XML-based payment authorization request message that includes financial processor 46 identification and retailer transaction identification information. This payment authorization is then sent to the financial processor 46. In various embodiments, ISO 8583, XML and NCPDPd.0 data structures are used for the authorization request messages between the switch 16 and the financial processor 46.

In various embodiments, the switch 16, (i) receives an authorization message back from the financial processor 46 or claims processor 54; (ii) creates a data log of authorized transactions based upon transaction identification number and (iii) creates an authorization message in the proper format to forward the message to the retailer 24.

In another embodiment of the present invention, the catalog management processor 40 creates a catalog 18 of UPC's for each of a participating retailer 24. Each catalog 18 includes first and second sets of UPC data. The first set is for national brand products and the second set for retailer 24 private label products.

The system and methods of the present invention enable in Comm retailers 24 to accept a financial transaction card based payment method at the point of sale for products, including but not limited to medicine and medical supplies, covered by a sponsor, including but not limited to Medicare and/or Medicaid. The present invention provides systems and methods which enable a replacement for reimbursement methods which have traditionally included manual claims or offline systems which do not interact with a retailer's 24 POS 18.

In some cases, the financial transaction card acceptance/redemption mechanism leverages existing POS-to-in Comm messaging interface for transaction processing.

In various embodiments, the present invention provides systems and methods that allow some sponsors to create lists that are specific to their organization and therefore restrict the publishing of the list to retailers 24. Other sponsors can choose to allow their list to be published and available within the catalog management server, which allows other sponsors to select a list that has already been created. As a non-limiting example, a state Medicaid program could create a list focused on preventative card, filled with vitamins and low-dosage aspirins and allow that list to be used by others, choosing to allow other states to take advantage of their efforts in identifying the most effective items for preventative card.

In one embodiment, financial transaction cards are not activated or purchased through a retailer POS transaction. The financial transaction cards are issued to a buyer by health insurance plans managing Medicare and Medicaid on behalf of Federal and State governments. In one embodiment, the buyer activates the financial transaction card via telephone and Interactive Voice Recognition technology. The financial transaction card can be used at participating retailers 24 to pay for eligible retail items and services as defined by the sponsor, included but not limited to over the counter medicines and medical supplies, as examples.

In one embodiment, a catalog 18 of UPCs is created and maintained for each participating retailer 24. The catalog 18 consists of two sets of UPC data; one set is for national brand products and the other set is for retailer 24 private label products. The catalog 18 reflects the definition of what is allowed for purchase using the catalog management processor 40/InComm financial transaction card. The catalog 18 must is in compliance with published guidelines from a sponsor including but not limited to the Centers for Medicare and Medicaid Services (“CMS”).

The catalog 18 is periodically updated to a national brands catalog 18 and then concomitant updates by the retailer 24 to a private label catalog 18. The catalog management processor 40 produces an approved national brands catalog 18 that is consistent with the approval agency requirements. The catalog management processor 40, as a proxy for the health plan and approval agency, is responsible to ensures that private label items offered by the retailer 24 are within the scope of the eligible item guidance. The retailer 24 is responsible for defining and maintaining the list of that retailer's 24 private label items that are within the scope of the national brands catalog 18. The catalog management processor 40 has the responsibility of assuring the health plan that all private label items offered by the retailer 24 are approved within the scope of the guidance. A single process flow is used to publish the initial catalog 18 and then maintain it going forward.

The initial build of catalogs 18 by the catalog management processor 40 begins with a complete list of national brands UPCs for given product families. The catalog management processor 40 narrows this list down. In one embodiment this is done alone by the catalog management processor 40 and in another embodiment it is achieved with both the processor 40 and with an approving sponsor or agency such as one that contains only the UPCs that are consistent with CMS guidance.

The national brand catalog 18 and the private label catalog 18 follow different paths to approval. The catalog management processor 40 controls the national brands catalog 18, but the retailer 24 controls their private catalog 18. The catalog management processor 40, as a proxy for the health plan or approval agency, reviews and approves items in the private label catalog 18.

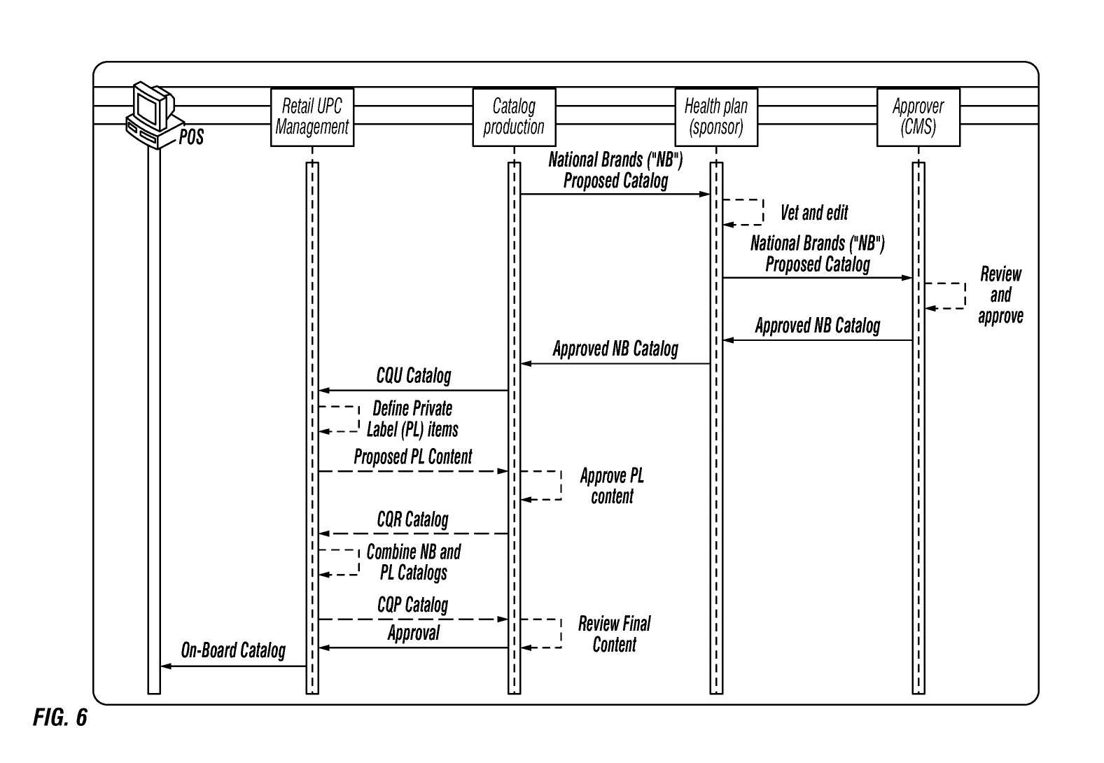

Dialog between the retailer 24 and the catalog management processor 40 can take the form of data files that are interchanged at various stages of proposal, approval and publication. FIG. 6 illustrates the process flow for publishing catalogs 18.

Following the initial release of a catalog 18, maintenance releases are performed on a periodic basis, such as a quarterly basis. The purpose for the maintenance release is to adjust the national brands catalog 18 to include additional products, remove outdated products or change the information pertaining to a specific UPC. If the national brand catalog 18 content changes it may impact the private label catalog 18 content. Hence a review process is necessary to ensure that the changes at the national level are reflected as changes at the private label level.

The retailer 24 processes the updates in order current to within a selected period of time, such as 90 days, of the last catalog 18 release. As a non-limiting example, catalogs 18 are released quarterly, forty-five days prior to a quarter (January, April, July, October), for processing and integration by the retailer 24 on or before the first day of each quarter. If a retailer 24 joins mid-term, an exception is allowed for the first cycle of updates. Only on the first update cycle, the retailer 24 may opt to wait for one cycle before updating their initial settings. For example, a retailer 24 joins May 1, and incorporates the catalog 18 from February 15 for the quarter starting April. The next catalog 18 update is released May 15, but the retailer 24 may skip this cycle, as a one-time event. But future catalog 18 releases will drive the incorporation on a 90-day basis going forward.

In regards to the private label items, example 1 is one embodiment of a quarterly process.

### Example 1

### Quarterly Process (Q1 Dates Provided as Example)

| Date | Process | |
|---|---|---|
| 11/15 | Quarterly update available to Retailer | Always the 15^{th}, |
| | | roughly 45 days in |
| | | advance |
| 12/1 | Retailer responds with updated catalog | Always the 1^{st}, |
| | which includes private label products | roughly 30 days in |
| | | advance |
| 12/10 | MG approves/denies private label | Always the 10^{th}, |
| | products and sends results back to | roughly 20 days in |
| | Retailer | advance |
| 01/01 | Retailer confirms updates in their | |
| | system | |

The catalog management processor 40 and retailer 24 communicate with each other during each step in the process of catalog management. In one embodiment, the File transfer process is via SFTP (FTP over SSH). The retailer 24 is given an SFTP address and a unique directory on an SFTP server at the catalog management processor 40 in which to place and retrieve data files that are to be transferred. Files are pushed to the SFTP site and pulled from the SFTP site by the retailer 24.

The catalog management processor 40 can automatically scan and process those files placed in a retailer's 24 SFTP directory periodically, which can be, as a non-limiting example, every two hours, and the like.

Example 2 is an example of the folder structure of the catalog management processor 24. It will be appreciated that other folder structures may also be utilized.

### Example 2

### Catalog Management Processor's Folder Structure

/Production (provided by the catalog management processor 40 to Retailer at start of service)

/in (for files coming from Retailer)

/out (for files going to Retailer)

The present invention can employ a variety of file naming conventions. Example 3 is specific embodiment, but others can be employed.

### Example 3

### File Naming Conventions

File Naming Conventions

The general format that is in use currently, takes the form “<MRID><file_type>_<file_state>_<file_number>_YYYYMMDDHHMMSS.txt”, where

“MRID” is a three character designator assigned by the catalog management processor 40 for the retailer 24.

The “file_type” is a three character or less designator that stands for the file type.

The “file_state” is a one letter designator, where “S” defines the file as a submission to MG from the retailer 24, and “R” defines the file as a return to the retailer 24 from the catalog management processor 40.

The “file_number” is a unique five character designator used to identify the content scope of the file.

“YYYY” stands for the four digit year,

“MM” stands for month of year.

“DD” stands for day of month.

“HHMMSS” stands for hours and minutes and seconds of day.

| File Name | Purpose | FTP folder |
|---|---|---|
| _YYYYMMDDHHMMSS.txt | File from retailer | /Production/In |
| | to MG | |
| _YYYYMMDDHHMMSS.txt | File from MG to | /Production/Out |
| | retailer | |

File & Data Format Conventions—Data files transferred between the catalog management processor 40 and retailers 24 can follow a variety of conventions including but not limited to the conventions listed below:

File and data formats can be ASCI. Fields within a file will be delimited by the pipe “|” symbol.
File Structure—Files can be of 3 record types,
Item Header Record: type “HDRD”.
Item Records: specified per file type.
Check Sum Record: type “CHKS”. The Checksum record will be the last record of the file. In most cases the checksum is simply a record count.
For CQU, a file header record with a record type “FILE”

Carriage Return & Line Feed—All records within a file can be terminated by a carriage return and line feed.

Field Types—“M”=Money, “D”=Date, “N”=Numeric, “A”=Alphanumeric.

Money Fields—Numeric fields can contain an actual decimal point and have 2 decimal positions, i.e.: “99999.99”. These may be signed numbers; positive numbers will have no sign, negative numbers will have a minus sign.

Date Fields—Date fields can be passed in the following format: MM/DD/YYYY.

Numeric Fields—Numeric fields can be left justified. i.e., 99999.99.

Alphanumeric Fields—Alphanumeric fields can be left justified, leading blanks removed.

Maximum length (Max Len)—These specify the maximum number of characters allowed for field length.

Required (Req'd)—“Y” equals required and the record can be considered invalid if data not included. “N”=not required.

File Names—The following are the names of the three files the can be used:

1. File Type Name: CQU—The catalog management processor 40 publishes the master catalog 18 that contains all active national brand items (“catalog 18”) on a periodic basis, such as quarterly. The CQU contains all of the national brand UPC codes that are acceptable for a given set of health plans.

2. File Type Name: CQR—The retailer 24 reviews the master catalog 18 (CQU) and creates the CQR catalog 18 of the retailer's 24 own private label products for review by the catalog management processor 40 the catalog management processor 40 responds with approval or denial.

3. File Type Name: CQP—The retailer 24 consolidates the final private label and national brands items into a single data file and submit this file for approval by the catalog management processor 40. The catalog management processor 40 responds with approval or denial.

The File Header of the specific CQU delineates all the health plans and health programs supported by the file.

A file header record is used. A suitable one is in Example 4.

### Example 4

### File Header Record

### Item Header Record

### Item Checksum Record

| Field Name | Comment | Max | Type | Req'd |
|---|---|---|---|---|
| Record Type | Always “File” for File Header | 4 | A | Y |
| Field | A list of Field Headers, pipe | 32 | A | Y |
| Headers | delimited | per | | |

| | | Max | | |
|---|---|---|---|---|
| Field Name | Comment | Len | Type | Req'd |
| Record Type | Always “CATI” for Header | 4 | A | Y |
| IIN Number | Primary IIN associated with the catalog (first | 6 | A | Y |
| | six digits of the IIN) | | | |
| CQU Version | File version, in the form “YYYYQV.V” where | 8 | A | Y |
| | YYYY is the year of publication | | | |
| | Q is the quarter of the year that the catalog | | | |
| | applies | | | |
| | V.V is the version number (1.0 is typical) | | | |
| CQU file | A unique number that represents the scope | 5 | A | Y |
| number | of the file (for example; file number 12345 is | | | |
| | the generic “smoking cessation” catalog | | | |
| Sub IIN record | Count of Sub IIN number and name records | 4 | I | Y |
| Count | in this File Header | | | |
| Sub IIN | Secondary IIN in the form XXXYY where: | 5 | A | Y |
| Number | XXX is the Health Plan ID | | | |
| | YY is the Plan Type | | | |
| Sub IIN Plan | Name of Health Plan and Program | 64 | A | N |
| Name | | | | |
| . . . n | Repeat for each applicable Sub IIN | 5 | A | Y |
| . . . n | Repeat for each applicable Sub IIN | 64 | A | N |

### Item Header Record

| | | Max | | |
|---|---|---|---|---|
| Field Name | Comment | Len | Type | Req'd |
| Record Type | Always “HDRD” for Header | 4 | A | Y |
| Field | A List of Field Headers, pipe | 32 | A | Y |
| Headers | delimited | per | | |

### Item Records

| | | Max | | |
|---|---|---|---|---|
| Field Name | Comment | Len | Type | Req'd |
| Record Type | Always “CATQ” for Quarterly Update | 4 | A | Y |
| MR ID | Assigned by MG. This ID contains the 3 digit | 3 | A | Y |
| | ID provided by MG to represent the retailer | | | |
| UPC_11 | Universal Product Code | 11 | A | Y |
| UPC_12 | Universal Product Code with check digit | 12 | A | Y |
| GTIN | Global Trade Identification Number | 14 | A | Y |
| DESC_29 | Long Description | 29 | A | Y |
| DESC_12 | Short Description | 12 | A | Y |
| Category Code | Category Code | 12 | A | Y |
| Category Name | Category Name | 128 | A | Y |
| Sub Category Code | Sub Category Code | 12 | A | N |
| Sub Category Name | Sub Category Name | 128 | A | N |
| FLC | Fine Line Code | 12 | A | N |
| Finest Category | Fine Line product description | 128 | A | N |
| UPCOLDUPC_11 | Prior UPC assigned to a product | 11 | A | N |
| Manufacturer | Product manufacturer name or abbreviation | 64 | A | Y |
| Product Size | Measure of volume or count | 48 | A | N |
| Unit of Measure | Unit of measure | 48 | A | N |
| Activity Code | (N = New, D = Delete, a deleted item will be | 1 | A | N |
| | flagged once then removed from the file | | | |
| | next update, X = Change to one of the | | | |
| | fields) | | | |
| HAMCODE | Unique product code - internal use only | 12 | A | N |

### Item Checksum Record

| | | Max | | |
|---|---|---|---|---|
| Field Name | Comment | Len | Type | Req'd |
| Record Type | Always “CHKS” for Checksum | 4 | A | Y |
| Record | Total number of item records, | 8 | N | Y |
| Count | NOT including this, checksum | | | |
| | record | | | |

The retailer 24 must produce a file of private label items to be submitted for approval by the catalog management processor 40 (as a proxy for the health plan and approval agent). The format for this file is described below. Upon review, items in the file that are not acceptable for inclusion in the Plan will be marked with a “N” in the activity code; all eligible items will be marked with an “E”. The file will be returned to the retailer 24 within five business days of submission. See the file naming convention discussion in Section 4 regarding identification of the submission and return file names.

### Example 5

### Retailer Catalog Response (File Type Name: CQR)

Item Header Record

| Field Name | Comment | Max | Type | Req'd |
|---|---|---|---|---|
| Record Type | Always “HDRD” for Header | 4 | A | Y |
| Field | A List of Field Headers, pipe | 32 | A | Y |
| Headers | delimited | per | | |

### Item Records

| | | Max | | |
|---|---|---|---|---|
| Field Name | Comment | Len | Type | Req'd |
| Record Type | Always “CATQ” for Quarterly Update | 4 | A | Y |
| MR ID | Assigned by MG. This ID contains the 3 digit | 3 | A | Y |
| | ID provided by MG to represent the retailer | | | |
| UPC_11 | Universal Product Code | 11 | A | Y |
| UPC_12 | Universal Product Code with check digit | 12 | A | Y |
| GTIN | Global Trade Identification Number | 14 | A | Y |
| DESC_29 | Long Description | 29 | A | Y |
| DESC_12 | Short Description | 12 | A | Y |
| Category Code | Category Code | 12 | A | Y |
| Category Name | Category Name | 128 | A | Y |
| Sub Category Code | Sub Category Code | 12 | A | N |
| Sub Category Name | Sub Category Name | 128 | A | N |
| FLC | Fine Line Code | 12 | A | N |
| Finest Category | Fine Line product description | 128 | A | N |
| UPCOLDUPC_11 | Prior UPC assigned to a product | 11 | A | N |
| Manufacturer | Product manufacturer name or abbreviation | 64 | A | Y |
| Product Size | Measure of volume or count | 48 | A | N |
| Unit of Measure | Unit of measure | 48 | A | N |
| Activity Code | E = Eligible, N = Not Eligible) | 1 | A | N |
| HAMCODE | Unique product code - internal use only | 12 | A | N |

### Item Checksum Record

| | | Max | | |
|---|---|---|---|---|
| Field Name | Comment | Len | Type | Req'd |
| Record Type | Always “CHKS” for Checksum | 4 | A | Y |
| Record | Total number of item records, | 8 | N | Y |
| Count | NOT including this, checksum | | | |
| | record | | | |

The retailer 24 produces a file that contains both approved private label items and applicable national brand items for approval by the catalog management processor 40 prior to deployment. The format for this file is described below. Upon review, items in the file that are not acceptable for inclusion in the Plan will be marked with a “N” in the activity code; all eligible items will be marked with an “E”. The file will be returned to the retailer 24 within five business days of submission. See the file naming convention discussion in Section 4 regarding identification of the submission and return file names.

### Example 6

### Production File for Deployment (File Type Name: CQP)

### Item Header Record

| | | Max | | |
|---|---|---|---|---|
| Field Name | Comment | Len | Type | Req'd |
| Record Type | Always “HDRD” for Header | 4 | A | Y |
| Field | A List of Field Headers, pipe | 32 | A | Y |
| Headers | delimited | per | | |

### Item Records

| | | Max | | |
|---|---|---|---|---|
| Field Name | Comment | Len | Type | Req'd |
| Record Type | Always “CATF” for Final Review | 4 | A | Y |
| MR ID | Assigned by MG. This ID contains the 3 digit | 3 | A | Y |
| | ID provided by MG to represent the retailer | | | |
| UPC_11 | Universal Product Code | 11 | A | Y |
| UPC_12 | Universal Product Code with check digit | 12 | A | Y |
| GTIN | Global Trade Identification Number | 14 | A | Y |
| DESC_29 | Long Description | 29 | A | Y |
| DESC_12 | Short Description | 12 | A | Y |
| Category Code | Category Code | 12 | A | Y |
| Category Name | Category Name | 128 | A | Y |
| Sub Category Code | Sub Category Code | 12 | A | N |
| Sub Category Name | Sub Category Name | 128 | A | N |
| FLC | Fine Line Code | 12 | A | N |
| Finest Category | Fine Line product description | 128 | A | N |
| UPCOLDUPC_11 | Prior UPC assigned to a product | 11 | A | N |
| Manufacturer | Product manufacturer name or abbreviation | 64 | A | Y |
| Product Size | Measure of volume or count | 48 | A | N |
| Unit of Measure | Unit of measure | 48 | A | N |
| Activity Code | E = Eligible, N = Not Eligible) | 1 | A | N |
| HAMCODE | Unique product code - internal use only | 12 | A | N |

### Item Checksum Record

| Field Name | Comment | | | |
|---|---|---|---|---|
| Record Type | Always “CHKS” for Checksum | 4 | A | Y |
| Record | Total number of item records, | 8 | N | Y |
| Count | NOT including this, checksum | | | |
| | record | | | |

Other embodiments of the invention will be apparent to those skilled in the art from consideration of the specification and practice of the invention disclosed herein. It is intended that the specification and examples be considered as exemplary only, with a true scope and spirit of the invention being indicated by the appended claims.

What is claimed is:

1. A system for multiple retailers to participate in restricted spend card programs, comprising:
a retailer infrastructure that includes a point of sale server coupled to a store concentrator and to a product tables/price book(s);
an adjudication processor coupled to the retailer;
a catalog management processor that includes a server coupled to the adjudication processor; the catalog management processor creating a catalog of UPC's for each of a participating retailer, each of catalog including first and second sets of UPC data the first set for national brand products and the second set for retailer private label products.

2. The system of claim 1, wherein each of a catalog reflects a definition of what is allowed for purchase using the catalog management server system and a financial transaction card.

3. The system of claim 1, wherein at least a portion of the catalogs are in compliance with published guidelines from the Centers for Medicare and Medicaid Services (“CMS”).

4. The system of claim 1, wherein at least a portion of the catalogs are in compliance with a health plan related code.

5. The system of claim 1, wherein at least a portion of the catalogs are in compliance with sponsor guidelines.

6. The system of claim 1, wherein each of a catalog is periodically updated to a national brands catalog and then with concomitant updates by a retailer to a private label catalog.

7. The system of claim 1, wherein the catalog management processor produces an approved national brands catalog consistent with approval agency requirements.

8. The system of claim 1, wherein the catalog management processor acts as a proxy for a health plan and approval agency.

9. The system of claim 1, wherein the catalog management processor ensures that private label items offered by a retailer are within a scope of eligible item guidance.

10. The system of claim 1, wherein retailers define and maintain a list of the private label items that are within a scope of the national brands catalog.

11. The system of claim 1, wherein the catalog management processor creates catalogs that are in compliance within a scope of regulatory guidance.

12. The system of claim 1, wherein the national brand catalog and the private label catalog follow different paths of creation and approval.

13. The system of claim 12, wherein the different paths converge into a single catalog that be deployed in a variety of forms.

14. The system of claim 1, wherein the catalog management processor controls the national brands catalog, and a retailer controls their private catalog.

15. The system of claim 1, wherein catalog management processor reviews and approves items in the private label catalog.

16. The system of claim 1, wherein the catalog management processor is configured to access a complete list of national brands UPCs for given product families.

17. The system of claim 16, wherein the catalog management processor narrows the complete list and creates a UPC list that contains only UPCs that are consistent with a sponsor guidance.

18. The system of claim 1, wherein communication between the catalog management processor and a retailer is in the form of data files.

19. The system of claim 1, wherein financial transaction cards are issued to a buyer by health insurance plans managing Medicare and Medicaid on behalf of Federal and State governments.

20. The system of claim 1, wherein a buyer has a financial transaction card activated via IVR.

21. The system of claim 1, wherein the adjudication processor includes a switch, an market basket analysis server that validates items in a market basket and a process control server, the market basket analysis server coupled to product catalogs and validates eligible items in the market basket, with content attributes in the market basket are communicated between the market basket analysis server and the switch.

22. The system of claim 21, wherein the switch, market basket analysis server, catalog management server and the process control server are configured to provide authorization of a financial transaction for items in the market basket.

23. The system of claim 21, wherein catalogs and financial account structure information are the inputs and are matched with items in the market basket that are then paid for from a buyer's purse, the purse being a link to a buyer's financial transaction funds.

24. The system of claim 21, wherein the market basket analyzer is configured to iteratively compare market basket items to catalog(s).

25. The system of claim 21, further comprising:
a financial processor coupled to the adjudication processor.
